(19) United States
(12) Patent Application Publication
(10) Pub. No.: US 2002/0196993 A1
(43) Pub. Date: Dec. 26, 2002

(54) Fiber optic supported sensor-telemetry system

(76) Inventor: Robert J. Schroeder, Newtown, CT (US)

Correspondence Address: Intellectual Property Department, Schlumberger-Doll Research, Old Quarry Rd., Ridgefield, CT, 06877, US

(21) Appl. No.: 09/892,144

(22) Filed: Jun. 26, 2001

(51) Int. Cl. G02B 6/26

(52) U.S. Cl. 385/12; 385/15

(57) ABSTRACT

Sensor-telemetry systems that combine an optical sensor and a non-optical sensor coupled with an optical fiber and methods of supporting multiple sensors including optical sensors and non-optical sensors on a single optical fiber are described.

### FIELD OF THE INVENTION

This invention relates to a fiber optic supported sensor-telemetry system and, in one embodiment, to a fiber-optic supported sensor-telemetry system for oilfield monitoring applications.

### BACKGROUND

Fiber optic sensor technology has developed concurrently with fiber optic telecommunication technology. The physical aspects of optical fibers which enable them to act as waveguides for light are affected by environmental influences such as temperature, pressure, and strain. These aspects of optical fibers which may be considered a disadvantage to the telecommunications industry are an important advantage to the fiber optic sensor industry.

Fiber optic sensors have been developed to measure a number of environmental effects, such as position (linear, rotational), fluid level, temperature, pressure, strain, pH, chemical composition, etc., and, in general, may be classified as either as extrinsic or intrinsic. In an extrinsic (or hybrid) fiber optic sensor, light being carried by an optical fiber exits the optical fiber, and an environmental effect modifies the light while outside of the optical fiber. In an intrinsic (or all fiber) fiber optic sensor, an environmental effect acts on the optical fiber, or through a transducer coupled with the optical fiber, to modify the light while still in the optical fiber. In both types of sensors, the environmental effect may modify the light in terms of amplitude, phase, frequency, spectral content, polarization or other measurable parameter. The modified light is carried by an optical fiber, which may or may not be the same optical fiber on which the light is inputted, to a detector or other opto-electronic processor that decodes the sensed information contained in the modified light. Additional background information about optical fibers and fiber optic sensors may be found, for example, in U.S. Pat. No. 5,841,131, which is incorporated herein by reference in its entirety.

Fiber optic sensors have been suggested for use in oil exploration and production applications. For example, the Optical Fluid Analyzer from Schlumberger, which is one type of extrinsic fiber optic sensor, has been successfully used in the oilfield for years. Fiber optic sensors, however, make up a small number of the sensors that are currently used in the oilfield. Most oilfield sensors output a non-optical signal, and the information sensed by these sensors is typically carried in the form of an electrical signal that is conveyed to a remote location over an electrical telemetry system. Thus, electrical telemetry systems for communicating with remote sensors are the norm in oil exploration and production applications.

### SUMMARY OF INVENTION

In a sensor-telemetry system according to the invention, an optical fiber provides telemetry of signals outputted by both optical as well as non-optical sensors. The sensor-telemetry system operates to support multiple sensors by coupling a first optical signal and a second optical signal onto the optical fiber. The first optical signal is outputted from the optical sensor. The second optical signal derives from the non-optical sensor. The first and second optical signals are transmitted over the optical fiber to a remote location where the first and second optical signals are demodulated from the optical fiber.

Further details and features of the invention will become more readily apparent from the detailed description that follows.

### BRIEF DESCRIPTION OF FIGURES

The invention will be described in more detail below in conjunction with the following Figures, in which:

FIG. 1 shows a schematic representation of one embodiment of a sensor-telemetry system of the invention;

FIG. 2 shows a schematic representation of an embodiment of a sensor-telemetry system deployed in a borehole; and

FIG. 3 shows a schematic representation of an experimental set-up demonstrating the concepts of a sensor-telemetry system according to the invention.

### DETAILED DESCRIPTION

The invention couples at least one optical sensor and at least one non-optical sensor onto an optical fiber. In operation, the optical fiber acts as a telemetry cable over which the signals outputted from the different types of sensors may be carried.

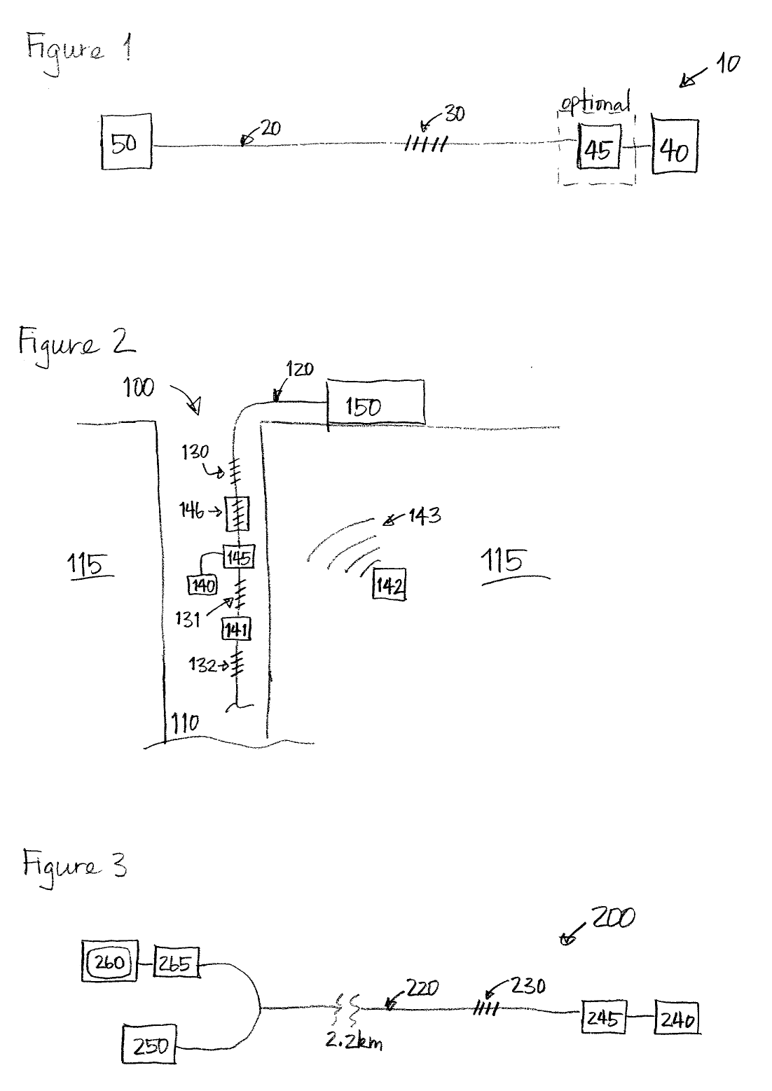

One embodiment of such a sensor-telemetry system is schematically illustrated in FIG. 1. The sensor-telemetry system 10 includes an optical fiber 20, an optical sensor 30 coupled with the optical fiber, and a non-optical sensor 40. The optical sensor 30 outputs a first optical signal that is coupled with the optical fiber 20. The non-optical sensor 40 outputs a second optical signal or, alternatively, a non-optical signal, such as an electrical signal, a magnetic signal, or an acoustic signal, in which case the non-optical signal is converted into a second optical signal by a converter 45 (which is considered optional in the invention depending on the output of the non-fiber optic sensor). The second optical signal is also coupled with the optical fiber 20, which transmits both the first and second optical signals to a remote location where the signals are demodulated by appropriate processing equipment 50. Such equipment 50 will typically include an optoel-ectronic device, such as a photodiode, photoemissive detector, photo-multiplier tube, or the like, to convert the optical signals into electrical signals that can be processed using standard processing electronics. A light source, such as a laser, incandescent or discharge lamp, light emitting diode (LED), or the like, optically coupled with the optical fiber 20 may also be located with the processing equipment 50, though the light source may be located elsewhere. Also, more than one light source may be optically coupled with the optical fiber. The light source provides light via the optical fiber to the optical sensor and, in some embodiments, also to a non-optical sensor.

A variety of optical sensors may be used in the invention. One type is an intrinsic fiber optic sensor based on a fiber Bragg grating. A fiber Bragg grating is formed in an optical fiber by inducing a spatially periodic modulation in the refractive index of the fiber optic core. When illuminated, the grating reflects a narrow spectrum of light centered at the Bragg wavelength, λ_{B}, given by Bragg's law:

λ_{B}=2nΛ,

where n is the effective index of refraction of the core and Λ is the period of the refractive index modulation. Environmental perturbations on the fiber Bragg grating, such as temperature, pressure and strain, cause a shift in the Bragg wavelength, which can be detected in the reflected spectrum of light. In a polarization-maintaining (or polarization-preserving) optical fiber, environmental effects such as strain and pressure may change the birefringence of the fiber, which also can be detected in the reflected spectrum.

Other types of intrinsic fiber-optic sensors may be used with the sensor-telemetry systems of the invention, including intrinsic fiber optic sensors based on total internal reflection for measuring, for example, vibration, pressure, or index of refraction changes; etalon-based fiber optic sensors for measuring strain, pressure, temperature, or refractive index; and interferometric fiber optic sensors, based on a Sagnac, Mach-Zehnder or Michelson interferometer, for measuring strain, acoustics, vibrations, rotation, or electric or magnetic fields. Optical probes that use total-internal reflection to discriminate between oil, water and gas, such as described in U.S. Pat. Nos. 5,831,743 to Ramos et al. and 5,956,132 to Donzier, also may be included in the sensor-telemetry systems of the invention.

Another type of optical sensor is an extrinsic fiber optic sensor. Extrinsic fiber optic sensors that may be included in the sensor-telemetry systems of the invention include intensity-based fiber optic sensors for measuring, for example, linear or rotary position; and fiber optic sensors for spectroscopic measurements (absorption or fluorescence), such as for chemical sensing or for measuring temperature, viscosity, humidity, pH, etc. For oilfield applications, in particular, extrinsic fiber optic sensors may include the Optical Fluid Analyzer from Schlumberger, which is described in, for example, U.S. Pat. No. 4,994,671 to Safinya et al.; an optical gas analysis module, such as described in U.S. Pat. No. 5,589,430 to Mullins et al.; and optical probes that detect fluorescence to measure characteristics of fluid flow, such as described in U.S. Pat. No. 6,023,340 to Wu et al.

Non-optical sensors which may be used in sensor-telemetry systems of the invention include pressure and temperature sensors, such as quartz and sapphire gauges, and video cameras. For oilfield applications in particular, non-optical sensors may include geophones, which convert seismic vibrations into electrical signals; induction sondes, which induce electrical signals that measure resistivity (or conductivity) in earth formations; current electrodes which measure resistivity (or conductivity); acoustic or sonic wave sensors; and other sensors which are typically incorporated into a logging or a drilling tool that is moveable through a borehole that traverses an oilfield or more permanently installed in an oilfield (e.g., in a well completion). Non-optical sensors may also include sensors based on micro-electro-mechanical systems (MEMS) and micro-optoelectro-mechanical systems (MOEMS). MEMS and MOEMS sensors have been developed to measure pressure, temperature, and a variety of other physical, as well as chemical, effects. MEMS and MOEMS sensors generally require less electrical power (typically on the order of microvolts or millivolts) to operate than other types of sensors (which typically require on the order of a few volts). In some embodiments of a sensor telemetry system of the invention, a photoelectric element may be embedded into or otherwise coupled with the MEMS or MOEMS sensor that, when illuminated by light being transmitted through the optical fiber, provides electrical power to the MEMS or MOEMS sensor.

While some non-optical sensors, e.g., some MOEMS sensors, output optical signals, some non-optical sensors output non-optical signals, such as electric, magnetic, or acoustic signals. To couple such non-optical signals with an optical fiber, a converter is used to convert the non-optical signal to an optical signal. The type of converter used depends on the type of signal outputted from the non-optical sensor. For example, for electrical signals, the converter includes an electro-optic device, such as a light emitting diode (LED), which converts electrical signals into intensity or frequency modulations in the light output of the LED. The optical output of the LED is coupled onto and transmitted over the optical fiber.

In another example, the converter may incorporate an intrinsic fiber optic sensor, such as those described above, to convert a non-optical signal into an optical signal. For example, a fiber Bragg grating or a fiber interferometer may be encircled, either partially or wholly, by a magneto-restrictive coating that converts magnetic field variations into strain modulations on the fiber which can be detected in the reflected spectrum. Coatings optimized for acoustic or electric field response may also be used. Such fiber optic converters may detect signals from extrinsic sensors that are connected to the optical fiber, or are positioned remotely from the optical fiber, for example, embedded in an earth formation or a cased well, and transmit a non-optical signal through the earth formation or through the well.

A single optical fiber, which generally has greater data bandwidth capacity than electrical cables, can support multiple optical signals using one or more of a variety of multiplexing techniques. For example, wavelength division multiplexing allows a plurality of optical signals, each at a different wavelength of light, to be transmitted simultaneously over an optical fiber. Another multiplexing technique, time division multiplexing, uses different time intervals, e.g., varying pulse duration, pulse amplitude and/or time delays, to couple multiple signals onto the optical fiber. Still another multiplexing technique, frequency division multiplexing, uses a different frequency modulation for each optical signal, allowing the multiplexed sensor signals to be differentiated based on their carrier frequencies. Other multiplexing techniques known in the art, such as coherence, polarization, and spatial multiplexing, may also be used to couple multiple optical signals onto a single optical fiber. The multiplexed signals may be demodulated using techniques known in the art.

Sensor-telemetry systems according to the invention may be useful for remote monitoring applications, such as for permanent monitoring and reservoir and well control applications where the number of cables that can be brought through the packers and well head outlets to the surface is necessarily limited. FIG. 2 illustrates one embodiment of an oilfield monitoring system according to the invention. The monitoring system 100 is shown being deployed in a borehole 110 that traverses an oilfield 115. An optical fiber 120 having a plurality of optical sensors 130, 131, 132 and a plurality of non-optical sensors 140, 141, 142 coupled therewith is deployed in the oilfield. A first non-optical sensor 140 (e.g., a quartz pressure gauge or current electrode) is coupled with the optical fiber 120 via a converter 145. A second non-optical sensor 141 (e.g., a MOEMS sensor) outputs an optical signal and so can be coupled with the optical fiber 120 without a converter. A third non-optical sensor 142 is embedded in the oilfield and transmits its output signal as magnetic, electric or acoustic waves 143 that travel through the oilfield. The third non-optical sensor 142 is coupled with the optical fiber 120 via a fiber optic converter 146 (e.g., a magneto-resistive coated fiber Bragg grating) that detects the output signal and converts it to an optical signal.

The optical fiber 120 sensor-telemetry string may be deployed in an open borehole, or with the casing and cemented in place in a cased well, or may be included on a wireline or as part of a logging or other tool that is moveable through the borehole. The optical fiber is shown being coupled with surface equipment 150 that may include one or more light sources, one or more detectors, and signal processing electronics. It should be noted that such equipment may reside in one location, or be distributed throughout the oilfield, on the surface and/or downhole.

The concepts of the invention were tested using the experimental set-up illustrated in FIG. 3. The experimental set-up 200 included a fiber Bragg grating strain sensor 230 and a video camera 240 coupled with an optical fiber 220. The video camera 240 was placed at one end of the optical fiber, and coupled with the optical fiber using a electrical video to optical converter 245 that converted the electrical video output of the video camera into optical signals at a wavelength of 1300 nm. At the other end of the optical fiber 220, which was approximately 2.2 km in length, a standard fiber beam splitter split the 1300 nm optical signals from the optical fiber 220 and directed them towards a standard television monitor 260 via an optical to electrical video converter 265. The data from the video camera is on the order of 6 MHz. The fiber Bragg grating strain sensor 240 was spliced into the optical fiber 220 between the video camera 240 and the television monitor 260. Light from the sensor electronics, shown at 250, was coupled with the optical fiber 220 and transmitted to the fiber Bragg sensor 230, which reflected an optical signal at a wavelength of 1550 nm back towards the sensor electronics 250. The 1550 nm optical signal is split from the optical fiber 220 and directed towards the sensor electronics 250, where it is detected and demodulated. Signals from the video camera and from the fiber Bragg sensor were simultaneously observed. The observed response of the video camera was not effected by strain applied to the fiber Bragg sensor, and the video signal did not effect the observed response of the fiber Bragg sensor, thus demonstrating the high bandwidth data telemetry capabilities of the invention.

The invention has been described with reference to certain examples and embodiments. However, various modifications and changes, as described throughout the above description, may be made to these examples and embodiments without departing from the scope of the invention as set forth in the claims.

I claim:

1. A sensor-telemetry system comprising:
at least one optical sensor;
at least one non-optical sensor; and
an optical fiber coupled with the optical sensor and the non-optical sensor and being arranged to carry signals outputted from the optical sensor and the non-optical sensor.

2. The system of claim 1, wherein the optical sensor comprises an intrinsic fiber optic sensor.

3. The system of claim 2, wherein the intrinsic fiber optic sensor comprises a fiber Bragg grating.

4. The system of claim 1, wherein the optical sensor comprises one of the following: a position sensor, a chemical sensor, a pH sensor, a pressure sensor, a temperature sensor, a strain sensor, a refractive index sensor, an acoustic sensor, and a magnetic field sensor.

5. The system of claim 1, wherein the non-optical sensor comprises one of the following: a flow sensor, pressure gauge, a temperature gauge, a geophone, an induction sensor, a current electrode, an acoustic sensor, a micro-electromechanical sensor, and a micro-optoelectromechanical sensor.

6. The system of claim 1, further comprising a converter coupling the non-optical sensor with the optical fiber.

7. The system of claim 6, wherein the converter comprises an electro-optic device.

8. The system of claim 6, wherein the converter comprises a fiber Bragg grating at least partially encircled by a coating that converts a non-optical signal into a strain on the fiber Bragg grating.

9. The system of claim 1, further comprising a detector coupled with the optical fiber.

10. The system of claim 9, wherein the detector comprises an opto-electronic device.

11. The system of claim 1, further comprising a light source optically coupled with the optical fiber.

12. An oilfield monitoring system comprising:
a optical fiber deployed in an oilfield;
a plurality of optical sensors coupled with the optical fiber;
a plurality of non-optical sensors; and
at least one converter coupling at least one of the plurality of non-optical sensors with the optical fiber, wherein the pluralities of optical and non-optical sensors are deployed throughout the oilfield.

13. The system of claim 12, wherein the optical fiber is deployed in a borehole that traverses the oilfield.

14. The system of claim 12, wherein at least one of the plurality of non-optical sensors is positioned remotely from the optical fiber.

15. The system of claim 14, wherein the non-optical sensor positioned remotely from the optical fiber outputs a non-optical signal that travels through the oilfield and is detected by the converter and converted to an optical signal that is coupled to the optical fiber.

16. The system of claim 15, wherein the converter comprises a fiber Bragg grating at least partially encircled by a coating that converts the non-optical signal to a strain on the fiber Bragg grating.

17. The system of claim 12, wherein the converter comprises an electro-optic device.

18. The system of claim 12, further comprising:
at least one light source coupled with the optical fiber, the light source outputting light that is carried by the optical fiber to at least one of the plurality of optical sensors; and
at least one detector coupled with the optical fiber, the detector detecting a signal carried by the fiber optic from at least one of the pluralities of optical and non-optical sensors.

19. The system of claim 18, wherein the light source and the detector reside at the surface of the oilfield.

20. A method of supporting multiple sensors on a optical fiber comprising:
a) coupling a first optical signal onto the optical fiber, the first optical signal being outputted from an optical sensor;
b) coupling a second optical signal onto the optical fiber, the second optical signal being derived from a non-optical sensor;
c) transmitting the first and second optical signals over the optical fiber to a location remote from the fiber optic and non-fiber optic sensors; and
e) demodulating the first optical signal and the second optical signal at the location.

21. The method of claim 20, wherein the first and the second optical signals are wavelength division multiplexed onto the optical fiber.

22. The method of claim 20, wherein the first and the second optical signals are frequency division multiplexed onto the optical fiber.

23. The method of claim 20, wherein the first and the second optical signals are time division multiplexed onto the optical fiber.

24. The method of claim 20, wherein the non-fiber optic sensor outputs a non-optical signal that is converted into the second optical signal.

25. The method of claim 20, further comprising:
transmitting a first wavelength of light through the optical fiber; and
inputting the first wavelength of light to the optical sensor, wherein the optical sensor modifies the first wavelength of light to produce the first optical signal.

26. The method of claim 20, wherein the first optical signal is one of a first plurality of optical signals from a plurality of optical sensors, and the second optical signal is one of a second plurality of optical signals from a plurality of non-optical sensors.

27. The method of claim 26, further comprising:
transmitting a plurality of wavelengths of light through the optical fiber; and
inputting the plurality of wavelengths of light to the plurality of optical sensors, wherein each optical sensor modifies one of the plurality of wavelengths of light to produce one of the first plurality of optical signals.
